(19) United States
(12) Patent Application Publication
(10) Pub. No.: US 2012/0146338 A1
(43) Pub. Date: Jun. 14, 2012

(54) ELECTRIC ALTERNATOR FOR WIND POWER GENERATORS

(76) Inventor: Giovanni Teglia, Piombino (LI) (IT)

(21) Appl. No.: 13/389,455

(22) PCT Filed: Aug. 2, 2010
(86) PCT No.: PCT/IT2010/000348

§ 371 Date: Feb. 8, 2012

(30) Foreign Application Priority Data
Aug. 11, 2009 (IT) FI2009A000185

(51) Int. Cl. F03D 9/00

(52) U.S. Cl. 290/55

(57) ABSTRACT

Wind power generator (10) with electrical alternator (13), of the type with blades whose direction of overall development follows substantially the direction of development of the axis of rotation (X) of the generator/alternator; said alternator comprising a rotor (15), forming the armature or the inductor of the alternator (13), designed to form at least in part the support structure (18, 19) for the blades (11) of the wind power generator (10) to which the alternator (13) is associated.

### CROSS REFERENCE TO RELATED APPLICATIONS

This application is a United States National Phase application of International Application PCT/IT2010/000348 and claims the benefit of priority under 35 U.S.C. §119 of Italian Patent Application FI2009A000185 filed Aug. 11, 2009, the entire contents of which are incorporated herein by reference.

### FIELD OF THE INVENTION

The present invention relates to the field of the production of electrical energy by means of wind power generators, and more in particular it refers to a wind power generator with electric alternator, of the type with blades presenting a direction of overall development that substantially follows the direction of development of its own axis of rotation, i.e. the axis of rotation of the generator/alternator.

### BACKGROUND OF THE INVENTION

As is well known, wind power generators can be divided into two types, those with axis of horizontal rotation with the blades radial relative to the axis itself, optimized to meet the wind according to a prevalently axial direction, and those with vertical or horizontal axis of rotation, in which the development of the blades follows the direction of the axis of rotation and in which the blades are optimized to meet the wind according to a direction prevalently perpendicular to the axis. In particular, the overall development of the blades of this latter type can be rectilinear, helical or any other development that overall follows the development of the axis of rotation. Obviously, such blades can be continuous or built with adjacent sectors which in any case overall present a direction of development concordant with the axis of rotation. Examples of such wind power generators are described for example in the Italian patent application no. LI2008A000002 and in the U.S. Pat. No. 7,362,004.

In these wind power generators with blades that follow the development of the axis of rotation, the blades are supported on a rotation shaft by means of arms that project radially from the shaft itself. At one end of the shaft is positioned an electric alternator that transforms the rotary motion of the shaft imparted by the blades into electrical energy.

There are different types of alternators, of the synchronous or asynchronous type. The former, with permanent magnet, are more widely used in the wind power generator industry than the latter. Alternators generally present a stator body on which are present the electrical windings (typically in the form of coils) and a rotor, located inside the stator, keyed onto a rotation shaft moved by the wind blades, whereon magnetic poles are present.

The structure of the alternator is generally separated by. the structure of the “wind turbine” i.e. the structure designed to “meet” the wind and to transform its energy into rotary motion to be transferred to the alternator. The connection of the shaft of the structure with the wind blades to the alternator takes place through appropriate connecting members which, as is obvious, produce mechanical losses and are subject to failures in case of excessive loads. A typical failure event can take place in the case of an unbalanced rotary load, due for example to the failure or to the deformation of a blade, a support spoke, a bearing or other.

Generally, on a wind power generator is positioned a single alternator (or at most two, positioned at the ends of the rotary shaft) which shall be dimensioned appropriately in relation to the wind energy to be exploited. It will be difficult for this alternator to be exploited for generators of a different power rating.

The assembly of wind power generators of the type with blades that follow the development of the axis of rotation is certainly more complicated than the assembly of generators with radial blades, in virtue of the plurality of support spokes that need to be positioned between the rotating shaft and the blades. Such spokes, although in theory they are designed with the utmost care, constitute unbalanced rotating masses, often because of deformations of the spokes themselves and of the presence of connecting/fixing members between the spokes, blades and shafts etc., not adequately considered during the design stage. Examples of alternators applied to wind power generators are shown in the following patents or patents applications: DE 36 29 872, JP 2000 249037, WO 2009/095612, US 2005/248160, US 2004/041409, WO 91/08394, WO 2008/141763.

### SUMMARY OF THE INVENTION

An important object of the invention is to allow to simplify the structure of a wind power generator with blades whose direction of overall development follows substantially the direction of development of the axis of rotation of the generator/alternator.

Another important object of the invention is to provide a wind power generator with an electric alternator, like the ones described above, that can cooperate to a reduction of the risks of failure of the structure of the generator to which the electric alternator it is applied.

Not the least object of the present invention is to provide a wind power generator that exploits the advantageous characteristics of a particular electric alternator.

These objects and other objects, which will be more apparent hereunder, are reached through a wind power generator with a plurality of electric alternators as provided in the appended claim 1.

Said wind power generator provides an electric alternator comprising a rotor, combined with a corresponding stator, that defines the inductor, or the armature, of the alternator itself and that forms at least in part the support structure for the blades of the wind power generator to which the alternator is associated.

Advantageously, with an electric alternator of this type, it is possible for example to simplify the structure of the generator to which the alternator is applied. In fact, whilst the structure of a traditional wind power generator with vertical/horizontal axis with blades having axial development normally comprises a rotating shaft, a certain number of wind blades and the related spokes anchoring to the rotation shaft whereon the alternator will then be keyed, the structure of a generator with alternator according to the invention instead is simplified with respect to the fixing of the spokes: the alternator according to the invention becomes the support of the anchoring spokes of the blades.

Conveniently, if a greater production of electrical energy is to be obtained, it will be possible to associate to the axis of rotation of the wind power generator multiple alternators which, carrying supporting arms of the blades will contribute to reinforce the support of the wind blades.

Moreover, the same alternators may be used on generators with longer axis of rotation, or a single type of alternator may be used for generators with a different power rating that vary mainly in relation to the length of the axis of rotation.

Another important result obtained with an alternator according to the invention relates to the fact that the rotary blade system of the generator is connected mechanically and integrally to the alternator and therefore the alternator will undergo every change in the mechanical load of the bladed system in its rotation. This will take place even for small and very small changes due to an inconsistent rotation caused by an imbalance because of failure, breakage or deformation of some member of the generator. These very small changes will lead to a distortion in the waveform of the output voltage of the alternator that will be detectable by an electronic system associated to the alternator. This electronic system in practice constitutes a part of a control and security system of the generator, as shall be described better farther on.

Briefly, the electronic system for controlling. the vibrations transmitted to the alternator comprises means for measuring the waveform output from the alternator, means for comparing said measured waveform with at least one ideal waveform, means for activating a procedure for slowing or stopping the bladed system when one or more pre-set threshold values are exceeded in the comparison between real waveform and ideal waveform.

In the preferred embodiment of the invention, considered more advantageous, the alternator comprises a first group, constituting the armature of the alternator, which comprises a central body, preferably of discoid shape, whereon, preferably in proximity to the periphery, are present the induction windings or other equivalent electrical means whereon electrical current is induced.

The alternator further comprises a second group, forming the inductor of the alternator, which comprises two coaxial and mutually facing parts, also preferably with discoid shape, that are fixed relative to one another. These two parts are in opposite position relative to the first group carrying the induction coils, that is, in the preferred embodiment, the central body whereon the induction windings are positioned. These two coaxial parts present magnetic poles that provide the magnetic field that invests the first group with the induction coils, during the relative rotation parts/first group on the axis of rotation of the alternator.

In this configuration, in the embodiment considered most advantageous, the rotor of the alternator that directly supports the blades structure of the wind power generator is formed by the second group with the two mutually opposite parts carrying the magnetic poles. This rotor is revolvingly arranged on a support with axial development, coaxial to the axis of rotation, forming the structure of the generator, whilst the first group with the windings is fixedly arranged on this axial support. Alternatively, in another possible embodiment, the rotor can be formed by the first group carrying the electrical windings.

To allow for a facilitated assembly of the alternator, in a particularly advantageous embodiment the two mutually opposite parts forming the first group are formed by distinct bodies. The union of these two parts in such a way that they rotate integrally around the axis of rotation, is assured by interconnecting means formed by the magnetic poles.

According to a particularly effective construction, the interconnecting means comprise a plurality of bridges made of ferromagnetic material, each of which presents, at opposite ends, respective magnetic elements. The set of the bridges and of the respective magnetic elements constitutes in fact the magnetic poles of the alternator.

More in particular, the two parts of the rotor present a crown of peripheral seats, open toward the outside and preferably with radial internal development, in which corresponding magnetic elements forming the magnetic poles of the rotor are inserted. The magnetic elements are oriented towards, or face, the interspace defined between the two parts and in which the first group carrying the induction coils (in the particular embodiment, the aforesaid discoid central body) is present.

Yet more in particular, according to a particularly useful embodiment, the above mentioned seats present openings on the lateral edges of the two parts of the rotor, whilst each bridge presents a substantially U-shape to allow the insertion of its ends into the opening of corresponding seats.

This structure of the alternator allows considerable ease of assembly and it also significantly facilitates the composition of the wind power generator. In fact, on at least one of the two opposite parts that form the rotor of the alternator can advantageously be provided fixing positions for the support means of the blades of the wind power generator, like for example radial arms at whose ends the blades are fixed. Alternatively, this part of the rotor can be constructed in a single piece with the supporting arms of the blades.

Obviously, said supporting arms, like other support means of the blades, can also not be fixed directly to the body that forms one of the two parts of the rotor, since it is possible that an appendix may project therefrom, for example coaxial to the axis of rotation, or a generic bracket that displaces in axial direction the starting point of the support relative to the part of the rotor carrying the magnetic poles.

An alternator structure thus described is particularly advantageous combined with a wind power generator. Obviously, the structure of the alternator linked to the simplicity of assembly can be considered useful even if it is not combined with the direct support of the blades, being usable along the axis of the rotor to increase the electrical power produced without necessarily having to support the blades, or being otherwise used in other fields of electrical energy production.

Obviously, the invention also comprises a wind power generator with blades whose direction of overall development follows substantially the direction of development of its own axis of rotation, in which at least one electric alternator as described above is present.

Preferably, said generator presents at least two alternators, of which at least one carrying directly corresponding support means for the wind blades; more preferably both said at least two alternators carry directly corresponding support means for the wind blades preferably arranged at the ends of the blades.

Advantageously, the wind power generator according to the invention may comprise an elongated axial support, fixed for example relative to an anchoring device to a bearing structure (such as a roof or a wall or other), coaxial relative to the axis of rotation of the blades. On this elongated axial support is positioned at least one alternator like the ones described above. Of this alternator, the two mutually opposite parts that carry the magnetic poles are arranged revolvingly, preferably with the interposition of bearings, on the axial support, whilst the first group the windings, for example in the form of a disc made of non-magnetic material with windings on the peripheral areas, is fixed on the axial support and does not rotate.

According to a preferred embodiment, the housings of one or more of said alternators are each formed by a pocket with a dovetailed cross section or with another equivalent shaping in which the ends are inserted and blocked of respective arms for supporting the wind blades.

According to a preferred embodiment, each said arm presents a rod-like structure, one end whereof is inserted and blocked in said housings.

According to a preferred embodiment, for each blade from said rotor project at least two rod-like support arms.

According to a preferred embodiment, the wind power generator comprises a wing profile that covers each group of said at least two arms for each blade.

According to a preferred embodiment, said central body of the alternator is made of plastic material.

According to a preferred embodiment, each winding of the alternator is embedded in said central body.

According to a preferred embodiment, each winding of the alternator forms a coil embedded in resin with preferably prismatic or cylindrical shape, each winding being encased in said central body.

According to a preferred embodiment, said central body is formed by two shells facing each other and mutually coupled, each winding being positioned in a respective niche obtained and open on at least one of said shells and closed by the other shell.

According to a preferred embodiment, said central body of the alternator presents on its two opposite faces passages designed to place the windings in communication with the exterior.

According to a preferred embodiment, said central body of the alternator centrally presents electric connection tracks connected to the ends of the windings, said tracks carrying the electric current produced on the windings to the axis of the alternator, where additional electric connections are present for transporting the electric current outside the alternator; preferably, according to a preferred embodiment, said tracks are printed directly on said central body. Preferably, according to a preferred embodiment, said tracks are printed on a board fixed to said central body. Preferably, according to a preferred embodiment, said board is positioned between said shells.

According to a preferred embodiment, said alternator is of synchronous type with permanent magnets with windings in air.

According to a preferred embodiment, said central body of said first group carrying the induction windings, preferably of the coil in air type, is made of non magnetic material and it preferably has discoid shape.

According to a preferred embodiment, said two parts of the alternator comprise two mutually facing coaxial bodies carrying said magnetic poles between which is positioned said central body with the windings, to one of said coaxial bodies with magnetic poles, on the outer face thereof, being directly fixed in contact a hub carrying the connection for arms supporting the blades of the wind power generator said hub is made of metallic material, preferably aluminum or an alloy thereof.

According to a preferred embodiment, the wind power generator comprises an axial support, fixed, coaxial with the axis of rotation of the blades, on which said at least one alternator is arranged, said two parts carrying the magnetic poles being revolvingly arranged, preferably with the interposition of means for reducing friction, on said axial support, said first group carrying the induction windings being fixed on said axial support.

According to a preferred embodiment, said support means for the wind blades comprise a plurality of arms, preferably radial, which project from the rotors of said alternators.

According to a preferred embodiment, at the free end of said arms being present through slots, counter-shaped to the profile of said blades, designed to house through longitudinal insertion the blades, at least two slots of respective arms belonging to two distinct alternators being aligned.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an axonometric view of the rotating part of a wind power generator according to the invention;

FIG. 2 is an axonometric view of an electric alternator according to the invention, showing in exploded view the ends of arms supporting wind blades to be fixed to the alternator itself;

FIG. 3 is a sectioned view according to a diameter plane of the alternator of FIG. 2;

FIG. 4 is an axonometric exploded view of the electric alternator of the previous figures, with a single magnetic pole indicated;

FIG. 5 is an axonometric exploded view of the electric alternator of the previous figures, with the indication of a plurality of magnetic poles indicated fictitiously in a position close to the induction windings of the stator group and the support whereon the rotor of the alternator can rotate;

FIG. 6 is an axonometric view of the rotating part of a further embodiment of wind power generator according to the invention;

FIG. 7 is an axonometric view of a further embodiment of alternator according to the invention, associated to the wind power generator of FIG. 6;

FIG. 8 is an axonometric sectioned view of the alternator of FIG. 7;

FIG. 9 is a sectioned view according to a diameter plane of the alternator of FIG. 7;

FIG. 10 is an axonometric view of the stator of the alternator of FIG. 7;

FIG. 11 is an axonometric exploded view of the stator of FIG. 10;

FIG. 12 is a diagram of the ideal waveform voltage signal produced by alternator (x-axis:time (sec); y-axis: voltage (mV));

FIG. 13 is a diagram of a real waveform produced by an alternator with little balance drawbacks;

FIG. 14 is a diagram of a signal error, opportunely conditioned, calculated from the difference between an ideal waveform signal and a real waveform produced by an alternator with a drawback.

### DESCRIPTION OF THE PREFERRED EMBODIMENTS

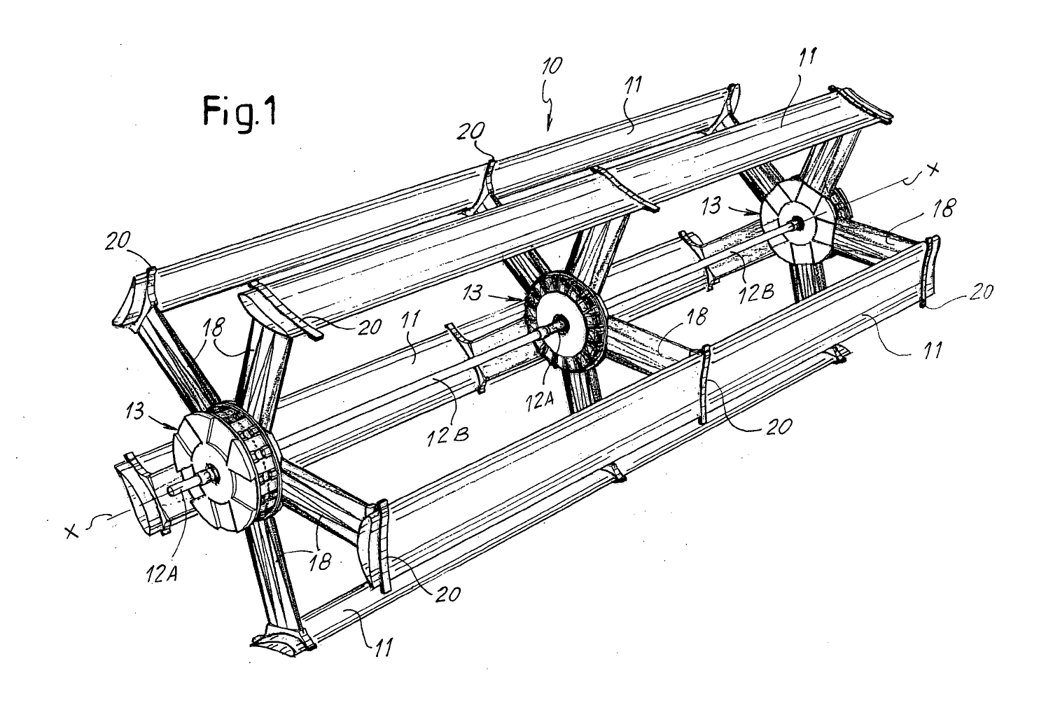

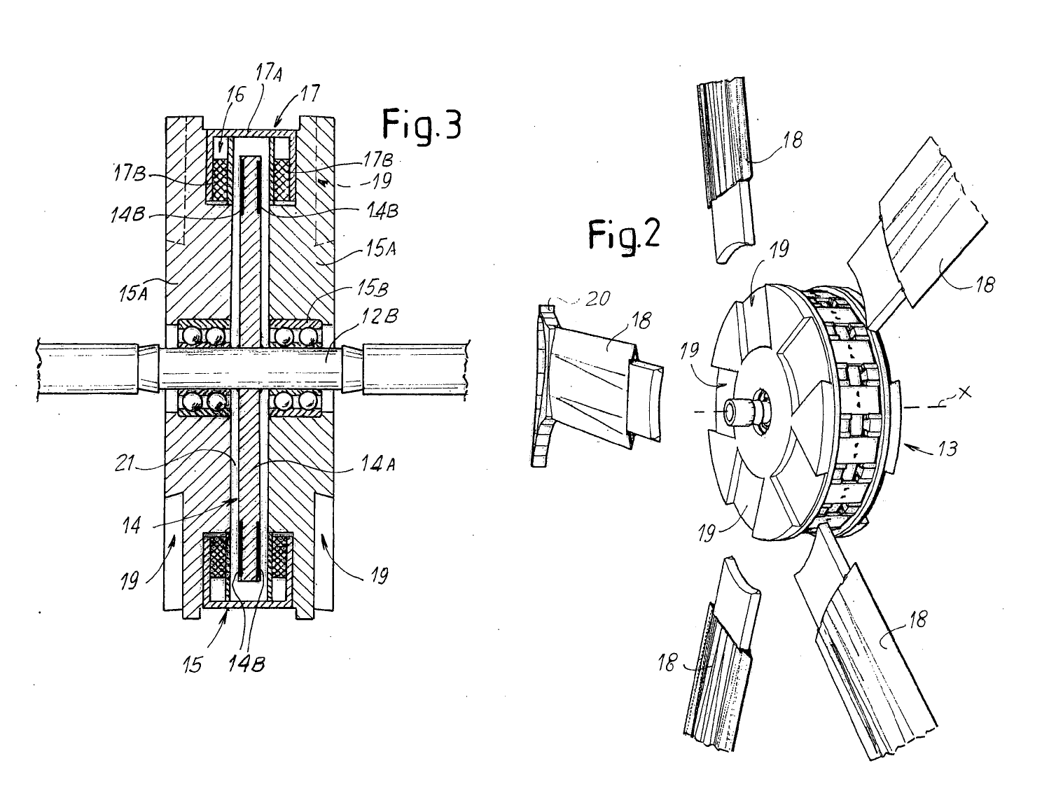

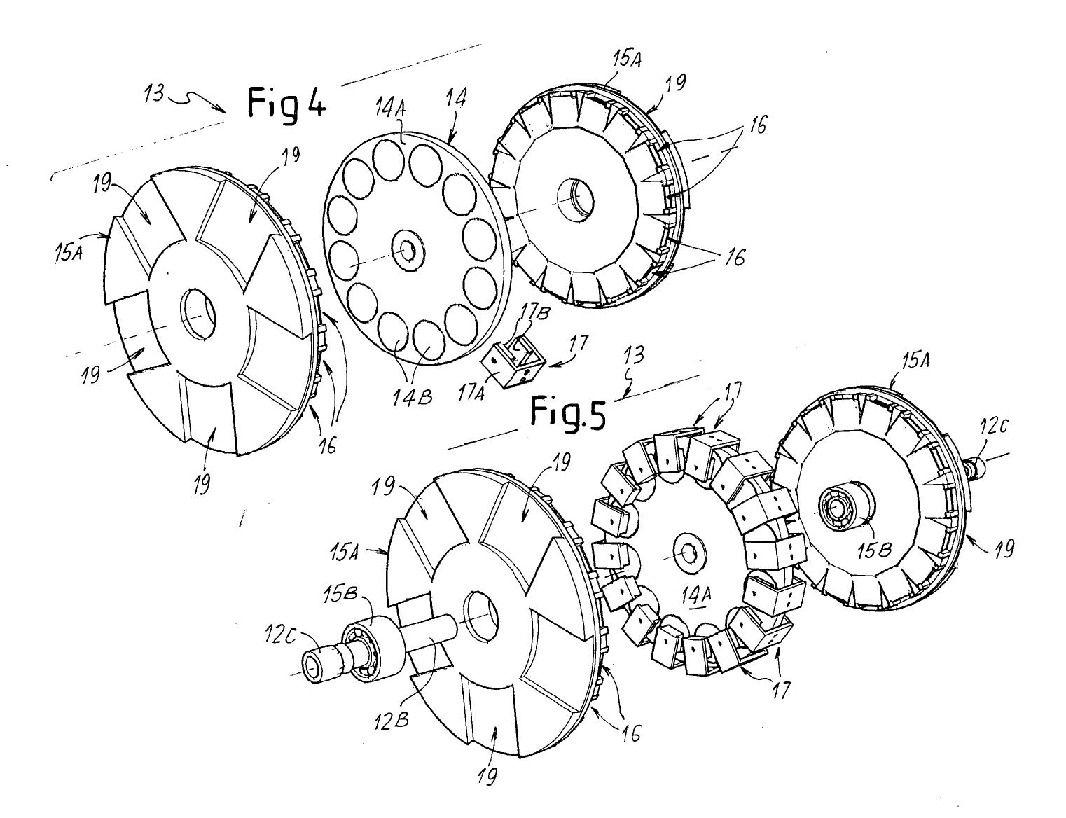

With reference to the aforementioned figures, a wind power generator according to the invention is schematically represented by its blade structure and it is indicated as a whole in FIG. 1 with the number 10. This wind power generator 10 is of the type with blades 11 whose direction of overall development substantially follows the direction of development of the axis of rotation X of the generator. In this example, the blades have rectilinear development with wing profile; clearly, in other embodiments these blades may for example follow the trend of the axis of rotation according to a helical development or yet they may be non continuous because they are constituted by mutually aligned sectors according to a preferred configuration, in any case always overall following the development of the axis of rotation. Obviously, also the shape of the profile may be the one best suited to the requirements.

The wind power generator 10, in this example, comprises an axial support whose development coincides with the axis of rotation X of the generator, formed for example by multiple aligned segments of rods, and in particular first support segments 12A for respective electric alternators 13 and second segments 12B interposed between first segments 12A. The axial support 12A-12B is fixed to an anchoring system to a bearing structure (neither of which is shown in the figures), such as for example the roof of a building.

As shown in FIG. 1, the wind power generator presents three electric alternators 13, but clearly its structure may be formed by any number of alternators arranged aligned on the axial support 12A-12B, each alternator with respective rod-shaped support segment 12A constituting in practice a modular unit composing the wind power generator.

The electric alternator 13 comprises a first group 14, forming the armature of the alternator, in turn comprising a central body 14A, in practice a discoid body made of non-magnetic material, in proximity to the circumferential periphery whereof are integrated induction windings 14B whereon electric current is induced, constituted for example by classic wire windings in air (but alternatively associated to an air gap), appropriately connected to a system for distributing the induced electric current, not shown in the figures. This central body 14A is holed centrally and it is fixed on the respective axial support segment 12B, for example keyed by interference. The central body 14A is coaxial to the axis of rotation X.

The electric alternator 13 further comprises a second group 15, forming the inductor of the alternator, in turn comprising two parts 15A, such as preferably two coaxial, mutually facing discoid bodies, opposite relative to the central body 14A, mounted revolvingly on the axial support segment 12A, for example with the interposition of respective bearings 15B.

On the lateral edges of each part 15A is obtained a plurality of seats 16, with openings on the same lateral edges, which present a development towards the interior of the respective body with substantially radial direction.

The two discoid bodies that form the two parts 15A of the rotor of the alternator 13 are fixed to each other, so that they can rotate integrally, by interconnecting means that comprise a plurality of U-shaped bridges 17A (one for each pair of seats 16) at whose ends are positioned magnetic elements 17B designed to be inserted inside corresponding seats 16. Each bridge with the magnetic elements forms in practice a magnetic pole 17 of the alternator 13. Obviously, the number of the of the magnetic poles 17 and, of the windings shall be dimensioned according to the technical requirements for the production of electric energy.

According to the invention, the rotor 15 (the second group) of the alternator 13 forms a part of the support structure for the blades 11 of the wind power generator 10, because supporting arms 18 for the blades develop directly therefrom, preferably in radial manner relative to the X axis.

In this example, first ends of the arms 18 are inserted and blocked in respective housings 19 formed by pockets, preferably with radial development, obtained on one of the two parts 15A, for example in correspondence of one of its faces oriented towards the outside relative to the central body 14A. These housings 19 present for example a dovetailed cross section or another shape which allows to prevent movements in the direction of the X axis of the arm. The blocking may be achieved for example also by means of threaded connections, interference or other.

Obviously, in other embodiments the arms may be connected in another way or be integral, i.e. in a single piece, with the respective parts 15A.

At the ends of the arms 18 opposite to the ends for fixing to the rotor 15, are present through slots 20, counter-shaped complementarily to the profile of the blades 11, designed to house the same blades by longitudinal insertion. As is readily apparent from the figures, the arms of the various alternators are equally distanced angularly and the slots 20 of corresponding arms are longitudinally aligned to allow the insertion of the blades.

The assembly of the wind power generator is as follows. For each alternator 13, a central body 14A (with the related windings already integrated) is fixedly keyed on a segment of axial support 12A. Then on the same segment of axial support 12A, from opposite parts relative to the central body 14A, are positioned the bearings 15B and then on said bearings are positioned the discoid bodies that form the opposite parts 15A of the rotor of the alternator.

Subsequently, the magnetic poles 17 are positioned placing the ends of the U-shaped body with the magnetic elements 17B inside respective pairs of seats 16 present on the lateral edges of the parts 15A. Opposite parts 15A and magnetic poles 17 (i.e. the rotor of the alternator) in practice form an interspace 21 in which the central body 14A (i.e. the stator of the alternator) is present. The magnetic poles can be further fixed on the parts 15A for example with threaded connections or other means.

Then, the first ends of the arms 18 are positioned and blocked in the housings 19 of the parts 15A. The axial support 12A of each alternator is then connected rigidly (for example through sleeves 12C) to a contiguous one by means of a respective segment of axial support 12B. Subsequently, the blades 11 are inserted in the slots 20 and then blocked.

Obviously, there may be multiple variations to the embodiment described herein. The opposite parts 15A can for example be constituted by bodies of different shape, for example with radial spokes. The same opposite parts can be built in a single piece or interconnected with different means from those formed by magnetic poles, for example connected by simple bolts.

The shape of the magnetic poles can also be different, for example not U-shaped but simply rectilinear and inserted in seats presenting parallel development to the axis X, or integrated in one of the two parts of the rotor. The shape of the central body of the stator can also be different, for example constituted by spokes integral to the fixed support.

The arms may be integral with the parts 15A, or fixed in removable or non removable manner (with threaded connections, welds, etc.). In this case, they can be positioned in appropriate housings or they can simply be positioned in areas adapted for fixing (for example for the presence of blocking holes or reference markings for positioning and/or welding). The arms can also develop close to the opposite parts 15A, starting from brackets or appendix-like portions that develop from said opposite parts 15A.

In other embodiments, deemed more complicated, but nonetheless within the scope of the present invention, the central body 14A can rotate on the axial support 12B whilst the opposite parts are fixed thereon. The arms can develop for example from an appendix coaxial to the axis X integral with the central body 14A and developing through a hole obtained on one of the two parts 15A.

Obviously, variations to the invention comprise, depending on technical requirements, any number of magnetic poles, any type and dimension of the permanent magnets, any shape of the supports of the permanent magnets, any number of induction coils, any electric characteristics of the windings, any type of air gap of the windings.

Figures from 6 to 11 show a second embodiment of alternator according to the invention and the way in which said alternator is connected to a generator according to the invention. Below, elements corresponding to elements described in the previous example are indicated with the same number.

In this example, the central body 14A, i.e. the stator, comprises two shells 14A′, preferably discoid, facing each other and mutually coupled, on the periphery whereof are obtained corresponding open niches 25 for the insertion of respective winding coils 14B. Obviously, the niches can also be obtained on a single shell 14A′, with the other shell closing the niches.

The central body 14A, on its outer faces, in this example presents passages 26, in the form of through slits, which place in communication the niches 25, and hence the coils 14B with the exterior. Obviously, said passages can be obtained on the central body 14A even when the coils are integrated directly in the body itself, i.e. when the body is made in a single piece.

Preferably, each winding forms a coil 14B embedded in resin with preferably cylindrical shape, but also prismatic shape or other shapes are possible. The windings can also be embedded in the central body 14A.

The central body 14A, whether it is made in a single piece, or in two (or more) shells, is preferably made of plastic material, as in the previous example.

The central body 14A has a circular board 27 positioned coaxially between the shells 14A′. On said board 27 (for example made of an insulating material of the type normally used to make substrates of printed circuit boards) are printed conductive tracks 28 (shown in a schematic way in FIG. 11) to which are connected on one side the ends of the windings and on the other side the electrical connections 29 to transport the electric current outside the alternator, which pass for example through the support of the central body itself. Note that the use of shells, coils, boards as describes enables rapidly to assemble the stator.

It should further be noted that the stator described above is, insofar as it is operating in an optimal manner therewith, is independent from the construction of the rotor, i.e, this stator could be used also with a rotor having different structure, for example also constituted by a single disk that coaxially faces the stator.

Advantageously, in this example (as preferably also in the previous example) also the two opposite parts 15A of the rotor are made of plastic material. This allows significantly to reduce the production costs of the alternator, which is particularly advantageous in the case of a wind power generator provided with a plurality of alternators.

If the torsional forces transmitted by the blades to the arms and hence to the rotor are excessive for a rotor made of plastic material, it is advantageous to use a hub 30, for example disk shaped, directly fixed to one of the two parts 15A, preferably made of a light metallic material, such as for example aluminum or an alloy thereof, or otherwise a particularly strong light material. On this hub may be fixed the support means for the blades, that are the arms 18.

The fixing between part 15A and hub 30 can take place for example through threaded connections or other interlocking connecting means, retaining means, etc., and also by means of glues, welds, etc. Obviously, in other embodiments the part 15A made of plastic material may be produced for example by overmolding directly on the hub, making them irreversibly integral.

In this example, the arms 18 are rods inserted in appropriate pockets 19 in the form of holes and blocked therein for example by means of stud bolts. In this case the blades are supported in correspondence of the ends of pairs of arms/rods 18. Preferably, each pair of rods 18 is covered externally with a wing profile 31 to improve the dynamic performance of the generator.

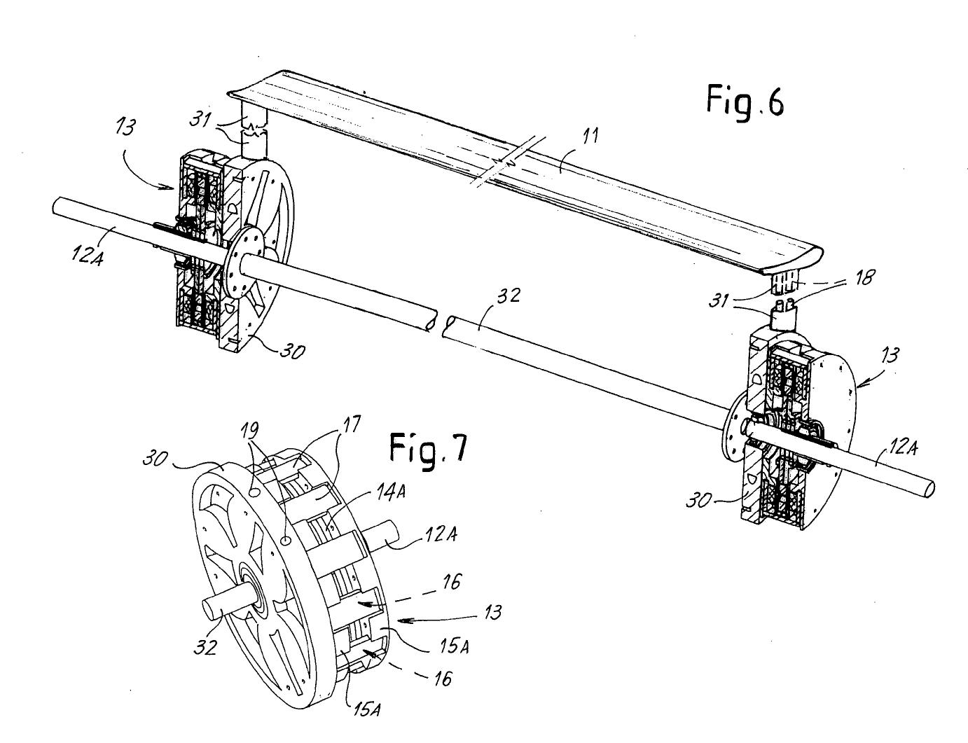

In the case of wind power generators according to the invention with multiple coaxial alternators from which the support arms of the blade depart, it is advantageous to use a supporting configuration of the alternators as shown in FIGS. 6, 8 and 9. In particular, in said configuration the rotors 15 of two alternators in succession are rigidly connected, for example through a rod-shaped connection 32 coaxial to the axis of rotation of the alternators. More in particular, this rod-like connection 32 is fixed for example through an end joint and threaded connections to the hub 30 (or, if the hub is not present, directly to a part 15A). Therefore, in a generator according to this example, the two alternators are positioned in substantially specular manner relative to an orthogonal plane to the axis of rotation passing through them. This configuration enables to avoid phase displacements between two adjacent alternators.

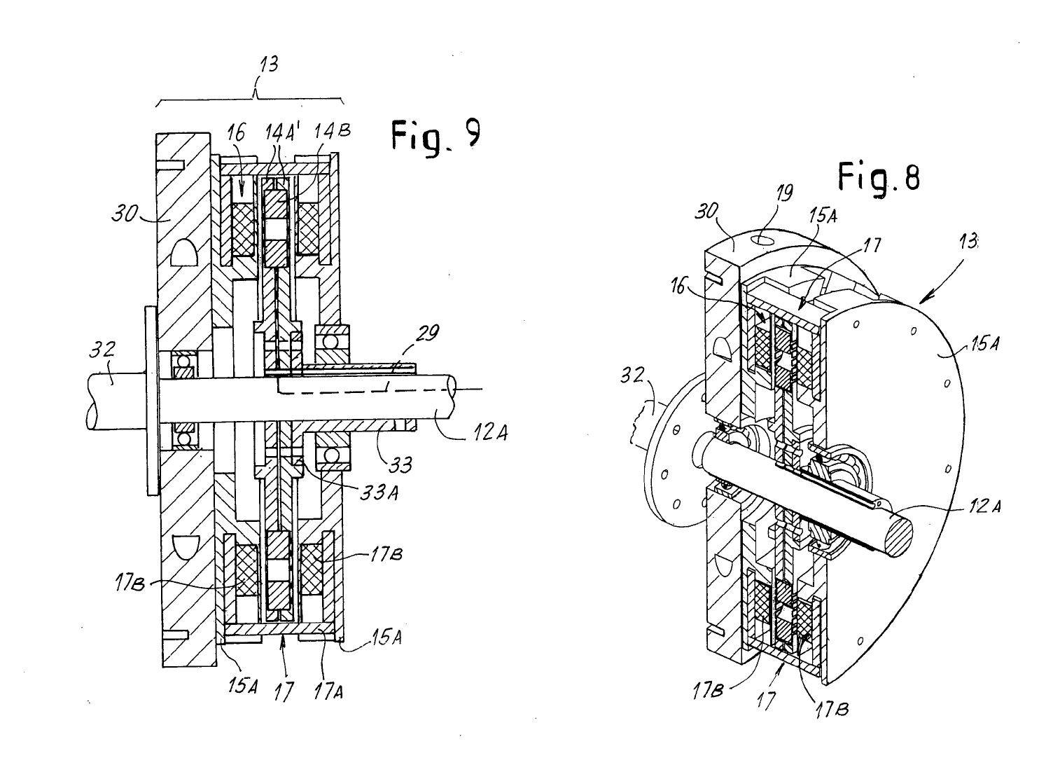

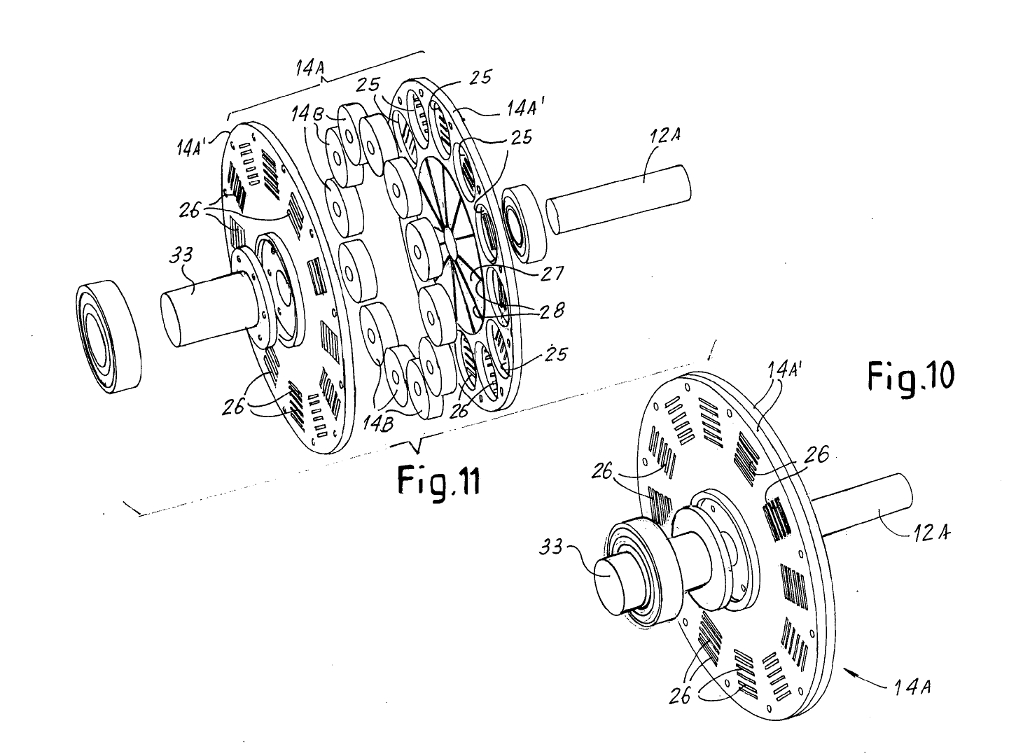

In particular, it should also be noted the construction of the support of the alternator in FIG. 8 or 9. In this case, the fixed support of the alternator comprises a shaft 12A passing through the center of the central body 14A, whereto it is integral by means of rigid connection to a bushing 33. This bushing is keyed on the shaft and it is fixed to the central body through a flanged portion 33A. The shaft 12A is fixed, i.e. it does not rotate. On the bushing 33 and at the end of the shaft 12A two ball bearings are present, on which a part 15A of the rotor and the hub 30 are respectively positioned. It should be noted that shaft 12A and rod-like connection 32 are separate (one is fixed, the other rotates integrally with the rotor).

According to the present invention, the wind power generator is provided with an electronic system for the control and safety of the rotation of the blades and in particular for monitoring the anomalous vibrations which the blades transmit to the alternator (this system is not shown in the figures). More in detail, the vibrations of the blades, through the related support means, will reach the bodies of the rotor that carry the magnetic poles of the alternator. These vibrations cause a micrometric displacement of the two bodies of the rotor in the axial direction relative to the induction coils. The axial displacement is added to the relative rotation of the rotor containing the induction coils, thereby obtaining a micrometric dynamic change of the distance between the magnets and the induction coils.

Since the output waveform is closely connected to the configuration assumed by the rotor with magnets and the stator with induction coils, the mechanical vibrations induced on the rotor will produce a deformation of the waveform output from the stator.

Mechanical vibrations will always be present in the rotating bladed system. The electronic control system evaluates when such vibrations become excessive; such an excess may derive from a failure or a dysfunction.

As the mechanical vibrations increase, the difference between the ideal waveform output from the alternator and the real waveform measured by the electronic control system will also increase. This “wave distortion” may have different shapes and characteristics according to the mechanical frequency of the anomalous vibration.

The electronic control system applied to the output of the alternator is able to discriminate the difference between ideal waveform and the real waveform through a mathematical algorithm and/or electronic filters. Once the danger threshold is identified, safety systems are activated to protect personnel and the wind power generator, for example by activating a short circuit system controlled by the alternator on shunt resistors that will tend to stop the bladed system (the electric current is bypassed on the shunt resistors that dissipate the electric power, thus stopping the rotor).

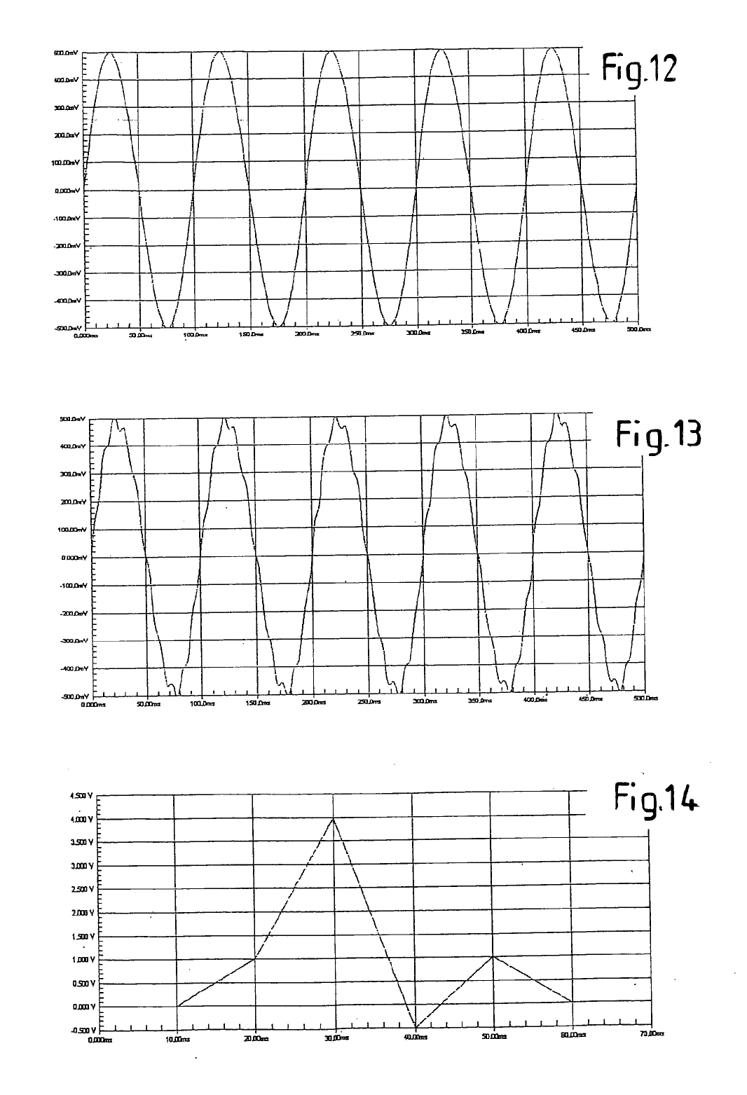

In FIG. 12 is shown a diagram of the ideal waveform voltage signal produced by alternator (x-axis:time (sec); y-axis: voltage (m V)), while in FIG. 13 is shown a diagram of a real waveform produced by an alternator with little balance drawbacks. In FIG. 13 is shown a signal error, opportunely conditioned, calculated from the difference between the ideal waveform signal and a real waveform produced by an alternator with a drawback.

Briefly, the electronic system for controlling the vibrations transmitted to the alternator comprises means for measuring the waveform output from the alternator, means for comparing such measured waveform with at least one ideal waveform, means for activating a procedure for slowing or stopping the bladed system when one or more pre-set threshold values are exceeded in the comparison between real waveform and ideal waveform.

In practice, what is illustrated represents merely possible non limiting embodiments of the invention, which can vary in forms and arrangements without however departing from the scope of the concept underlying the invention. Any reference numbers in the appended claims are provided for the sole purpose of facilitating the reading thereof in the light of the description hereinbefore and the accompanying drawings and do not in any way limit the scope of protection of the present invention.

While specific embodiments of the invention have been shown and described in detail to illustrate the application of the principles of the invention, it will be understood that the invention may be embodied otherwise without departing from such principles.

1. A wind power generator with a plurality of electric alternators, comprising:
blades whose directions of overall development substantially follows a direction of development of rotation of the generator/alternator, wherein each electric alternator of said plurality of electric alternators comprises a rotor, forming an armature or an inductor of the alternator, designed to form at least partially a support structure for the blades of the wind power generator, at least two electric alternators carrying directly corresponding support means for supporting the wind blades.

2. A wind power generator as claimed in claim 1, wherein each said electric alternator comprises:
a first group, forming the armature of the alternator, comprising a central body on which induction windings or equivalent electric means are present, on which electric current is induced; and
a second group, forming the inductor of the alternator, comprising two mutually coaxial and facing parts, one of said facing parts being fixed relative to the other of said facing parts, arranged in opposite positions relative to said first group carrying the induction windings, said two coaxial parts presenting magnetic poles designed to define a magnetic field designed to run over on the central body of said group the induction windings, said first group, carrying the windings, and said second group, carrying the magnet poles, being designed to rotate one relative to the other relative to the axis of rotation of the wind power generator, said rotor, on which the blades of the wind power generator are supported through the corresponding means, being formed by one of said first group and said second group.

3. A wind power generator as claimed in claim 2, wherein said rotor of said electric alternator is formed by said second group carrying the magnet poles which is designed to rotate on a support with axial development, fixed, coaxial to the axis of rotation of the wind power generator to which the alternator is associated, said first group carrying the induction windings being designed to be arranged in a fixed manner on said axial support.

4. A wind power generator as claimed in claim 2, wherein said two parts of said electric alternator are separate bodies and the magnet poles form interconnecting means for said two parts.

5. A wind power generator as claimed in claim 4, wherein said interconnecting means of said electric alternator comprises a plurality of bridges in a ferromagnetic material, each of said bridges carrying, at opposite ends, respective magnetic elements, the bridges with the respective magnetic elements defining the magnetic poles of the alternator.

6. A wind power generator as claimed in claim 5, wherein said two parts of said electric alternator present peripheral seats, open towards the outside, inside which corresponding magnetic elements are inserted, forming the magnetic poles of the rotor, said magnetic elements facing the interspace defined between said two walls and in which said first group is present, carrying the induction windings.

7. A wind power generator as claimed in claim 6, wherein said seats of said electric alternator present apertures on the lateral edges of said two parts, each of said bridges presenting a substantially U-shape so as to allow the insertion of its ends in the apertures of corresponding said seats.

8. A wind power generator as claimed in claim 2, wherein said central body of said first group carrying the induction windings, preferably of the coil in air type, is made of non magnetic material and said central body preferably has discoid shape.

9. A wind power generator as claimed in claim 2, wherein said central body is made of plastic material.

10. A wind power generator as claimed in claim 8, wherein each winding is embedded in said central body.

11. A wind power generator as claimed in claim 8, wherein each winding forms a coil embedded in resin with preferably prismatic or cylindrical shape, each winding being encased in said central body.

12. A wind power generator as claimed in claim 8, wherein said central body is formed by two shells facing each other and mutually coupled, each winding being positioned in a respective niche obtained and open on at least one of said shells and closed by the other of said shells.

13. A wind power generator as claimed in claim 2, wherein said central body presents on two opposite faces thereof passages designed to place the windings in communication with the exterior.

14. A wind power generator as claimed in claim 2, wherein said central body centrally presents electric connection tracks connected to the ends of the windings, said tracks carrying the electric current produced on the windings to the axis of the alternator, where additional electric connections are present for transporting the electric current outside the alternator.

15. A wind power generator as claimed in claim 14, wherein said tracks are printed directly on said central body.

16. A wind power generator as claimed in claim 15, wherein said tracks are printed on a board fixed to said central body.

17. A wind power generator as claimed in claim 16, wherein said board is positioned between said shells.

18. A wind power generator as claimed in claim 1, wherein said electric alternator is of synchronous type with permanent magnets with windings in air.

19. A wind power generator as claimed in claim 2, wherein said first group is a stator and said second group is a rotor.

20. A wind power generator as claimed in claim 2, wherein on at least one of said two parts fixing/blocking positions are present for fixing/blocking the support means of the blades of the wind power generator.

21. A wind power generator as claimed in claim 2, wherein said two parts are constituted by two equal bodies, each presenting, preferably on the opposite face relative to the first group carrying the induction windings, a plurality of housings for the ends of support elements for supporting the blades of the generator, said bodies comprising said two parts having a discoid shape.

22. A wind power generator as claimed in claim 20, wherein the bodies comprising said two parts have discoid shape.

23. A wind power generator as claimed in claim 2, wherein the bodies of said at least two parts that carry said magnetic poles are made of plastic material.

24. A wind power generator as claimed in claim 2, wherein at least one of said two parts comprises a bracket or an appendix, to which support means are fixed for supporting the blades of the wind power generator.

25. A wind power generator as claimed in claim 20, wherein said two parts comprise two mutually facing coaxial bodies carrying said magnetic poles between which is positioned said central body with the windings, to one of said coaxial bodies with magnetic poles, on the outer face thereof, being directly fixed in contact a hub carrying the connection for arms supporting the blades of the wind power generator.

26. A wind power generator as claimed in claim 25, wherein said hub is made of metallic material, preferably aluminum or an alloy thereof.

27. A wind power generator as claimed in claim 2, wherein one of said two parts of the second group carrying the magnetic poles is integral with support means for supporting the blades of the wind power generator to which the alternator is associated.

28-40. (canceled)

41. A wind power generator as claimed in claim 1, wherein at least two said alternators are arranged coaxially to the axis of rotation of the blades of the generator, in which the respective rotors carry said support means for the blades and in which said respective rotors are rigidly connected to each other.

42. A wind power generator as claimed in claim 1, further comprising an electronic system for controlling the vibrations transmitted to the alternator by the blades, said electronic system comprising means for measuring the waveform output from the alternator, means for comparing said measured waveform with at least one ideal waveform, means for activating a procedure for slowing or stopping the bladed system when one or more pre-set threshold values are exceeded in the comparison between real waveform and ideal waveform.

43. A wind power generator with at least one electric alternator, comprising:
blades whose directions of overall development substantially follows a direction of development of an axis of rotation of the generator/alternator, wherein said at least one electric alternator comprises a rotor, forming an armature or an inductor of the alternator, designed to form at least partially a support structure for the blades of the wind power generator, at least two electric alternators carrying directly corresponding support means for supporting the wind blades and said electric alternator further comprising:
a first group, forming the armature of the alternator, comprising a central body on which induction windings or equivalent electric means are present, on which electric current is induced;
a second group, forming the inductor of the alternator, comprising two mutually coaxial and facing parts, one of said facing parts being fixed relative to the other one of said facing parts, arranged in opposite positions relative to said first group carrying the induction windings, said two coaxial parts presenting magnetic poles designed to define a magnetic field designed to run over on the central body of said group the induction windings, said first group, carrying the windings, and said second group, carrying the magnet poles, being designed to rotate one relative to the other relative to the axis of rotation of the wind power generator, said rotor, on which the blades of the wind power generator are supported through the corresponding means, being formed by one of said first group and said second group.
